(19) United States
(12) Patent Application Publication
(10) Pub. No.: US 2026/0236553 A1
(43) Pub. Date: Aug. 13, 2026

(54) GEOMETRIC ALGEBRA TRANSFORMERS SCALING VIA VIRTUAL NODES EMBEDDINGS

(71) Applicant: QUALCOMM Incorporated, San Diego, CA (US)

(72) Inventors: Julian SUK, Amsterdam (NL); Gabriele CESA, Diemen (NL); Thomas Markus HEHN, Delft (NL); Arash BEHBOODI, Amsterdam (NL)

(21) Appl. No.: 19/057,834

(22) Filed: Feb. 19, 2025

Related U.S. Application Data
(60) Provisional application No. 63/755,962, filed on Feb. 7, 2025.

(51) Int. Cl. G06F 17/14

(52) U.S. Cl. CPC G06F 17/14

(57) ABSTRACT

Systems and techniques are described herein for data processing. For instance, a process can include embedding information generated from multivector inputs processed from input data associated with a three-dimensional space to a virtual node; processing the multivector inputs using the virtual node to obtain a set of virtual tokens; and processing, via a geometric algebra transformer, the set of virtual tokens to generate a set of output virtual tokens that are equivariant with respect to translations and rotations to the input data.

### CROSS-REFERENCE TO RELATED APPLICATIONS

This application claims the benefit of U.S. Provisional Patent Application No. 63/755,962, filed Feb. 7, 2025, which is hereby incorporated by reference in its entirety and for all purposes.

### TECHNICAL FIELD

The present disclosure generally relates to processing data using machine learning systems. For example, aspects of the present disclosure include systems and techniques for providing geometric algebra transformer (GATr) scaling via virtual nodes embeddings (VINE).

### BACKGROUND

Various technical fields (e.g., molecular dynamics, astrophysics, material design, and robotics) deal with geometric data, including points, directions, surfaces, orientations, and so forth. Neural network models (e.g., reinforcement learning algorithms) are often modeled to control objects or material (e.g., robots, molecules, materials, etc.) in such environments and may sample states, take actions, and observe rewards or results for the actions. For every state and a possible action, the neural network model may predict an expected reward and an expected future state. Modeling the expected reward is a regression problem and modeling the expected future state is a density estimation problem. Current neural network models treat data as an unstructured vector of numbers, which results in the networks requiring a large amount of training data and which reduces the ability of the networks to generalize to new situations. For example, transformer models may be able to handle generic modalities and data discretization, but computational capacity and cost for such models may be tied to a number of input tokens, making handling large input data sets impractical.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for data processing are provided. In one illustrative example, an apparatus to process data is provided. The apparatus includes: one or more memories configured to store the data; and one or more processors coupled to the one or more memories and configured to: embed information generated from multivector inputs processed from input data associated with a three-dimensional space to a virtual node; process the multivector inputs using the virtual node to obtain a set of virtual tokens; and process, via a geometric algebra transformer, the set of virtual tokens to generate a set of output virtual tokens that are equivariant with respect to translations and rotations to the input data.

As another example, a method for data processing is provided. The method includes embedding information generated from multivector inputs processed from input data associated with a three-dimensional space to a virtual node; processing the multivector inputs using the virtual node to obtain a set of virtual tokens; and processing, via a geometric algebra transformer, the set of virtual tokens to generate a set of output virtual tokens that are equivariant with respect to translations and rotations to the input data.

In another example, a non-transitory computer-readable medium having stored thereon instructions is provided. The instructions, when executed by at least one processor, cause the at least one processor to: embed information generated from multivector inputs processed from input data associated with a three-dimensional space to a virtual node; process the multivector inputs using the virtual node to obtain a set of virtual tokens; and process, via a geometric algebra transformer, the set of virtual tokens to generate a set of output virtual tokens that are equivariant with respect to translations and rotations to the input data.

For another example, an apparatus to process data is provided. The apparatus includes means for embedding information generated from multivector inputs processed from input data associated with a three-dimensional space to a virtual node; means for processing the multivector inputs using the virtual node to obtain a set of virtual tokens; and means for processing, via a geometric algebra transformer, the set of virtual tokens to generate a set of output virtual tokens that are equivariant with respect to translations and rotations to the input data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates a table of embeddings of common objects and transformations, according to aspects of the disclosure;

FIG. 2 is a diagram illustrating an example use of a geometric algebra transformer, according to aspects of the disclosure;

FIG. 3 is a diagram illustrating an example of the geometric algebra transformer, according to aspects of the disclosure;

FIG. 4 is a conceptual diagram of a ML model based on a GATr network using virtual nodes embeddings, in accordance with aspects of the present disclosure;

FIG. 5 illustrates a neural network model that includes various components including an example of a GATr network using virtual nodes embeddings, in accordance with aspects of the present disclosure;

FIG. 6 is a flow diagram illustrating a process for data privacy, in accordance with aspects of the present disclosure; and

FIG. 7 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Geometric data is highly structured. For example, geometric data can be categorized into certain types, such as a three-dimensional coordinate of an object, a velocity vector, a weight of the object, etc. These geometric types of objects can inform a system of typical operations that can be performed with respect to the objects. However, traditional machine learning models are not configured to process such geometric data structures, which can lead to inefficiencies. For example, traditional machine learning models (e.g., neural network models) treat data as an unstructured vector of numbers, rather than geometric objects, require large amount of training data, and generalize poorly to new situations.

Another aspect of the highly structured nature of geometric data is that, when coordinate systems are changed (e.g., by moving the origin of a coordinate system to a new location), the numbers with which the data is represented can change, but the actual behavior of the system does not change. The fact that the behavior does not change is also reflected in how geometric data is structured. In robotics and other situations where a machine learning model (e.g., a neural network) learns behaviors or patterns from training data, it can be very beneficial to take the structure of geometric data into account.

Machine learning systems should be generalizable to situations outside of examples provided in training data. For example, a neural network can typically be trained for one type of situation (e.g., for classification, image segmentation, etc.). However, the neural network should also perform well when a new situation arises. Machine learning systems should also be efficient with respect to data samples. For instance, when a neural network is trained on limited data (e.g., 100, 500, 1000, or other number of training samples for the neural network model), the network should still perform well. Machine learning algorithms, including reinforcement learning algorithms, generally do not take into account the structure of geometric data, in which case they are often not able to generalize to new situations and are not sample efficient.

In some cases, a geometric algebra transformer (GATr) as part of a new neural network architecture that can be used in many different contexts, such as robotic control, molecular dynamics, climate science, autonomous driving, planetary trajectory predictions, among others.

Various fields of science and engineering are related to geometric data (e.g., points, directions, surfaces, orientations, etc.), including molecular dynamics, astrophysics, material design, robotics, robotic control, molecular dynamics, climate science, autonomous driving, planetary trajectory predictions, among others. The geometric nature of data provides a rich structure. The systems and techniques described herein take into account the notion of common operations between geometric types (e.g., computing distances between points, applying rotations to orientations, etc.), and of a well-defined behavior of data under transformations of a system. The systems and techniques also consider the independence of certain properties of coordinate system choices. For example, when learning from geometric data (e.g., learning relations between geometric objects from data), the systems and techniques incorporate the rich structure related to various geometric types into the architecture. Incorporating the rich structure into the architecture can improve the performance of the neural network architecture (e.g., by improving sample efficiency and generalization of the model).

The GATr described herein provides a general-purpose network architecture for geometric data. The GATr utilizes geometric algebra, equivariance, and transformers to perform one or more tasks. For example, to naturally describe both geometric objects as well as their transformations in three-dimensional space, the GATr can represent data as multivectors of the projective geometric algebra [symbol] _{3,0,1}. Geometric (or Clifford) algebra is a principled yet practical mathematical framework for geometrical computations. The particular algebra [symbol] _{3,0,1} extends the vector space [symbol] to 16-dimensional multivectors, which can natively represent various geometric types and E(3) poses. Unlike the O(3) representations popular in geometric deep learning, this algebra faithfully represents absolute positions and translations.

As noted above, the GATr can utilize equivariance. For example, the GATr is equivariant with respect to E(3), the symmetry group of three-dimensional space. To this end, disclosed are several new E(3)-equivariant primitives mapping between multivectors, including equivariant linear maps, an attention mechanism, nonlinearities, and normalization layers.

As further noted above, the GATr can also make use of transformers. For instance, due to its favorable scaling properties, expressiveness, trainability, and versatility, the transformer architecture has become the de-facto standard for a wide range of problems. The GATr is based on the transformer architecture, in particular on dot-product attention, and hence inherits these benefits.

In general, a transformer is a deep learning model. A transformer can perform self-attention (e.g., using at least one self-attention layer), differentially weighting the significance of each part of the input (which includes the recursive output) data. Transformers can be used in many contexts, including the fields of natural language processing (NLP) and computer vision (CV). Like recurrent neural networks (RNNs), transformers are designed to process sequential input data, such as natural language, with application to tasks such as translation and text summarization. However, unlike RNNs, transformers process the entire input all at once. The attention mechanism provides context for any position in the input sequence. For example, if the input data is a natural language sentence, the transformer does not have to process one word at a time. The approach allows for more parallelization than RNNs and therefore reduces training times. Compared to RNN models, transformers are more amenable to parallelization, allowing training on larger datasets.

The GATr described herein can be based on processed data from a three-dimensional space or context that is prepared with geometric algebra representations. For example, the GATr can be designed for the geometric structure of the three-dimensional space (e.g., a robotic environment) by processing the data and can be useful for high level control of such contexts (e.g., robotics and/or other applications). The GATr can also be equivariant with respect to symmetries of the three-dimensional space. For instance, the GATr can be configured with multiple novel network layers that maintain E(3) equivariance. The term E(3) relates to the group of rotations, reflections and translations in three-dimensional space.

In some aspects, the GATr can receive a multivector input, process the input using various layers or engines such as equilinear layers, normalization layers, a geometric attention layer, and geometric product engines to generate a multivector output. Data can be extracted from the multivector output and used to perform a task, such as controlling a movement of a robotic arm or other task. Other example applications include molecular modeling and planetary trajectory modeling. A multivector represents both geometrical objects (linear subspaces) and operators (rotations and reflections). There may be a plurality of values in a multivector (e.g., embedded into the multivector), where each value can represent a respective object (e.g., a geometric object, such as a scalar, a vector, a bivector, a trivector, a pseudoscalar, etc.) of a respective operator.

As indicated above, a machine learning (ML) model including GATr can include transformers and process tokens. As transformers are scaled to process increasingly large and/or complex data sets, transformers may start to suffer from quadratic scaling complexity where the runtime scales proportional to a square of the input size (e.g., token size), potentially resulting in large increases in computational costs and computational resources as input data increases. This scaling is made worse as certain large datasets, such as meshes for medical applications, wireless channel models, and the like, may be difficult to discretize as reducing token count through simple downsampling can severely impact the usefulness of the model in some applications.

Systems, apparatuses, processes (also referred to as methods), and computer-readable media (collectively referred to as “systems and techniques”) are described herein for processing data. For example, input data associated with a three-dimensional (3D) space may be input to a ML model. In some cases, the input data may be processed into multivector inputs. The multivector inputs may be considered tokens. Information may be generated based on the multivector inputs and this information may be embedded into virtual nodes. For example, a center of mass and a set of eigenvectors may be generated based on the multivector inputs.

The center of mass and set of eigenvectors may be generated as a part of a principal component analysis (PCA) of the multivector inputs. In some cases, PCA may be a linear dimensionality reduction technique. In some cases, embedding the information generated from the inputs may be performed based on all possible sign combinations of eigenvectors generated as a part of the PCA. For example, PCA analysis may result in sign ambiguity and different combinations of possible signs may be considered. In some cases, eigenvectors with a positive determinant may be used and other eigenvectors may be removed. The determinant may be a scalar-valued function of the entries of a matrix. In some cases, embedding the generated information (e.g., from the PCA) may allow the virtual nodes to be equivariant with respect to translations and rotations to the input data. In some cases, embedding the generated information may be performed using portions of the GATr, such as by using two bilinear layers and an equivariant linear layer of the GATr.

The multivector inputs may be processed using the virtual nodes to generate virtual tokens. Virtual nodes may be learned nodes (e.g., embedding vectors) which are independent of the input, but can be combined with information generated from the inputs, such as information from a PCA of the input (e.g., multivector input). In some cases, multiple virtual nodes may be generated for an input. For example, PCA analysis may result in sign ambiguity and multiple combinations of the output values of the PCA analysis may be encoded into multiple virtual nodes. The virtual nodes allow the input data, such as 3D input data associated with a 3D space, to be encoded, for example, via a cross-attention layer, to a latent space represented by the virtual nodes. In some cases, the virtual tokens may be virtual nodes combined with the input data. Thus, V virtual nodes combined with N input data results in, V virtual tokens. The input tokens may describe the generic input of the particular task at hand. As an example with a point cloud, the token may describe the point cloud where each token may be a 3D coordinate as well as a mesh and where each input token may contain information about the vertices (e.g. position and surface normal). In the case of the cortical surface meshes, there may also be additional scalar information (e.g., curvature, quantities of medical interest, etc.). The virtual tokens then may describe, information such as spatial positions and tangential planes but since they are freely learnable within the geometric algebra, intuition may be lost. The virtual tokens may be processed by a geometric algebra transformer (GATr) to generate output virtual tokens that are equivariant (e.g., not only invariant) with respect to translations, reflections, and rotations of the input data. The number of virtual tokens may be reduced as compared to the input tokens (e.g., vectors of the multivector inputs). In some cases, the output virtual tokens may be decoded into output tokens for output.

A brief overview of geometric algebra (GA) is provided. Whereas a plain vector space such as [symbol] allows one to take linear combinations of elements x and y (vectors), a geometric algebra additionally has a bilinear associative operation (e.g., the geometric product, which can be denoted as xy). By multiplying vectors, so-called multivectors can be obtained. The multivectors can represent both geometrical objects and operators. Like vectors, multivectors have a notion of direction as well as magnitude and orientation (sign) and can be linearly combined.

Multivectors can be expanded on a multivector basis, including products of basis vectors. For example, in a 3D GA with orthogonal basis e₁, e₂, e₃, a general multivector takes the form

$$x = {x}_{s} + {x}_{1} {e}_{2} + {x}_{2} {e}_{2} + {x}_{3} {e}_{3} + {x}_{12} {e}_{1} {e}_{2} + {x}_{13} {e}_{1} {e}_{3} + {x}_{23} {e}_{2} {e}_{3} + {x}_{123} {e}_{1} {e}_{2} {e}_{3} , \qquad ( 1 )$$

with real coefficients (xₛ, x₁, . . . , x₁₂₃)∈ [symbol] . Thus, similar to how a complex number a+bi is a sum of a real scalar and an imaginary number, a general multivector is a sum of different kinds of elements. Indeed, the imaginary unit i can be thought of as the bivector e₁e₂ in a 2D GA. These are characterized by their dimensionality (grade), such as scalars (grade 0), vectors eᵢ (grade 1), bivectors eᵢeⱼ (grade 2), all the way up to the pseudoscalar e₁ . . . e_{d} (grade d).

The geometric product is characterized by the fundamental equation vv= [symbol] v, v [symbol] , where [symbol] ∵ [symbol] is an inner product. In other words, one can require that the square of a vector is its squared norm. In an orthogonal basis, where [symbol] eᵢ, eⱼ [symbol] ∝δᵢⱼ, one can deduce that the geometric product of two different basis vectors is antisymmetric: eᵢeⱼ=−eⱼeᵢ. The antisymmetry can be derived by using

$${v}^{2} = 〈 v , v 〉 to show that {e}_{i} {e}_{j} + {e}_{j} {e}_{i} = {( {e}_{i} + {e}_{j} )}^{2} - {e}_{i}^{2} - {e}_{j}^{2} = 0 .$$

Since reordering only produces a sign flip, one can only get one basis multivector per unordered subset of basis vectors, and so the total dimensionality of a GA is

$${\sum }_{i = 0}^{d} ( \begin{matrix}d \\ k\end{matrix} ) = {2}^{d} .$$

Moreover, using bilinearity and the fundamental equation one can compute i=0 k the geometric product of arbitrary multivectors.

The symmetric and antisymmetric parts of the geometric product are called the interior and exterior (wedge) product. For vectors x and y, these are defined as [symbol] x, y [symbol] =(xy+yx)/2 and x∧y≡(xy−yx)/2. The former is indeed equal to the inner product used to define the GA, whereas the latter is new notation. Whereas the inner product computes the similarity, the exterior product constructs a multivector (called a blade) representing the weighted and oriented subspace spanned by the vectors. Both operations can be extended to general multivectors.

The final primitive of the geometric algebra is the dualization operator x [symbol] x*. It acts on basis elements by swapping “empty” and “full” dimensions, e.g. sending e₁ [symbol] e₂₃.

Another concept is the use of projective geometric algebra. In order to represent three-dimensional objects as well as arbitrary rotations and translations acting on them, 3-dimensional (3D) geometric algebra may not be enough. For example, multivectors of 3D geometric algebra can only represent linear subspaces passing through the origin as well as rotations around it. A common technique for expanding the range of objects and operators is to embed the space of interest (e.g. [symbol] ) into a higher dimensional space whose multivectors represent more general objects and operators in the original space.

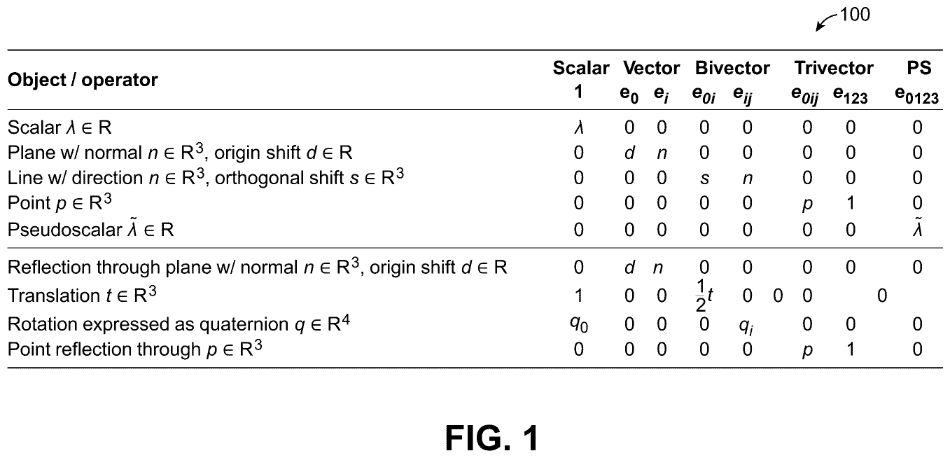

FIG. 1 illustrates a table 100 providing an example dictionary of the embeddings. The embeddings shown in the table 100 illustrate embeddings of common geometric objects and transformations into the projective geometric algebra [symbol] _{3,0,1}. The columns show different components of the multivectors with the corresponding basis elements, with i, j∈{1,2,3}, j≠i, i.e. ij∈{12,13,23}. For simplicity, one can fix gauge ambiguities (the weight of the multivectors) and leave out signs (which depend on the ordering of indices in the basis elements).

In some aspects, the multivector is 1 unit with 16 numbers. The 16-dimensional vector is structured such that each of the components of the vector has a particular type associated with it. A first property of the multivector is that each component can be of a particular type of data. For example, the first number may be a scalar number that could be any number that does not have a direction or location. The next three components can be a regular 3-dimensional vector. There are several particular properties that apply to the structure. The first is that there is a well-established dictionary regarding how to represent different geometric objects. In other words, there can be a rule for how to represent the position of an object. There may be another rule for how to represent object orientations and there can be rules for representing directions, lines, planes, and also for operators acting on objects like translations or rotations.

A second property of the multivector is that there is one operation between the vectors known as the geometric product. The geometric product is a convenient operation because it allows for the computation of the typical operations that would be computed between geometric data with just a single operation. For example, the geometric product between two multivectors that each represent the coordinates of a point will identify the distance between the points. In another example, the geometric product between the representational point and that of a translation vector will identify how to shift the point by the amount of the translation vector. The geometric product is one operation that implements a lot of typical geometric operations.

A scalar product between two vectors provides a single number and a cross product between two vectors provides another vector. Both of these operations are generalized in geometric algebra and in the geometric product between multivectors. The geometric product maps two multivectors into another multivector and the output contains both the typical scalar product and the typical cross product.

Therefore, using the multivector structure as the data representation as described herein and using the geometric product as an operation between multivectors is part of the underlying idea of the geometric algebra transformer. The result is one data type and an associated standard operation that can essentially describe all the data types and operations that are expected to occur often in a three-dimensional environment. With few parameters in the neural network, the system can learn typical operations easily.

As noted previously, systems and techniques described herein provide a geometric algebra transformer (GATr) as part of a neural network architecture or model. The GATr can operate with the projective geometric algebra [symbol] _{3,0,1}. For example, a fourth homogeneous coordinate x₀e₀ can be added to the vector space, yielding a 2⁴=16-dimensional geometric algebra. The metric of [symbol] _{3,0,1} is such that

$${e}_{0}^{2} = 0 and {e}_{i}^{2} = 1$$

for i=1, 2, 3. In the setup the 16-dimensional multivectors can represent 3D points, lines, and planes, which need not pass through the origin, and arbitrary rotations, reflections, and translations in [symbol] .

Another concept relates to representing transformations. In geometric algebra, a vector u can act as an operator, reflecting other elements in the hyperplane orthogonal to u. Since any orthogonal transformation is equal to a sequence of reflections, this allows one to express any such transformation as a geometric product of (unit) vectors, called a (unit) versor u=u₁ . . . uₖ. Furthermore, since the product of unit versors is a unit versor, and unit vectors are their own inverse (u²=1), the product of unit versors form a group called the Pin group associated with the metric. Similarly, products of an even number of reflections form a Spin group. In the projective geometric algebra [symbol] _{3,0,1}, the Spin group include the double cover of E(3) and SE(3), respectively. The double cover means that, for each element of E(3), there are two elements of Pin(3, 0, 1), e. g. both the vector v and −v represent the same reflection. Any rotation, translation, and mirroring—the symmetries of three-dimensional space—can thus be represented as [symbol] _{3,0,1} multivectors.

In order to apply a versor u to an arbitrary element x, one uses the sandwich product:

$${p}_{u} ( x ) = \{ \begin{matrix}{uxu}^{- 1} & if u is even \\ u \hat{x} {u}^{- 1} & if u is odd\end{matrix} \qquad ( 2 )$$

Here \hat{x} is the grade involution, which flips the sign of odd-grade elements such as vectors and trivectors, while leaving even-grade elements unchanged. Equation 2 thus gives a linear action (i. e. group representation) of the Pin and Spin groups on the 2^{d}-dimensional space of multivectors. The sandwich product is grade-preserving, so this representation splits into a direct sum of representations on each grade.

The systems and techniques described herein can represent 3D objects by representing planes with vectors. The systems and techniques can require that the intersection of two geometric objects is given by the wedge product of their representations. Lines (the intersection of two planes) can be represented as bivectors and points (the intersection of three planes) can be represented as trivectors. Such 3D object representations can lead to a duality between objects and operators, where objects are represented like transformations that leave them invariant. As described previously, table 100 in FIG. 1 provides a dictionary of these embeddings. It is easy to check that this representation is consistent with using the sandwich product for transformations.

For the concept of equivariance, one can construct network layers that are equivariant with respect to E(3), or equivalently its double cover Pin(3, 0, 1). A function ƒ: [symbol] _{3,0,1}→ [symbol] _{3,0,1} is Pin(3, 0, 1)-equivariant with respect to the representation ρ (or Pin(3, 0, 1)-equivariant for short) if

$$f ( {ρ}_{u} ( x ) ) = {ρ}_{u} ( f ( x ) ) \qquad ( 3 )$$

for any u∈Pin(3, 0, 1) and x∈ [symbol] _{3,0,1}, where Pu (x) is the sandwich product defined in Eq. (2).

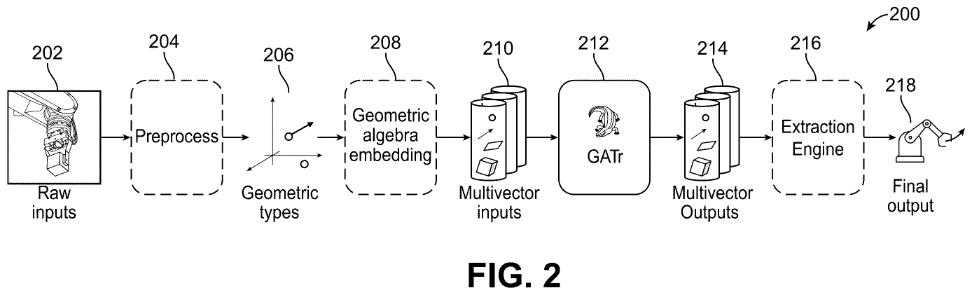

FIG. 2 illustrates a neural network model 200 that includes various components including an example of a geometric algebra transformer (GATr) network 212 described herein. If necessary, raw inputs are first preprocessed into geometric types. The geometric objects are then embedded into multivectors of the geometric algebra [symbol] _{3,0,1}, following the recipe described in FIG. 1.

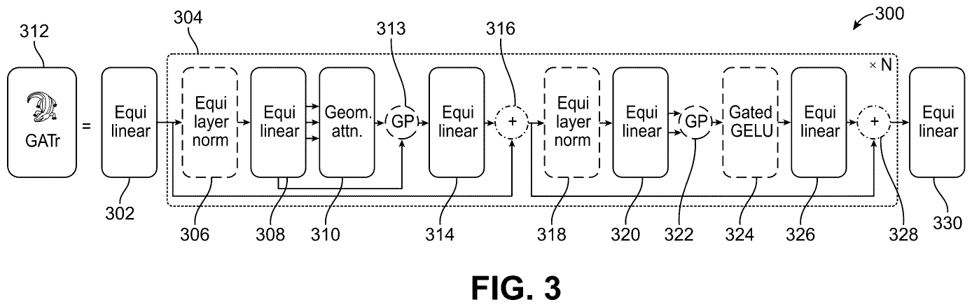

The multivector-valued data are processed with the GATr network 212. FIG. 3 illustrates the GATr network 212 architecture in more detail. The GATr network 212 includes N transformer blocks, each including of an equivariant multivector LayerNorm, a geometric attention layer 310 (e.g., an equivariant multivector self-attention layer), a residual connection, another equivariant LayerNorm, an equivariant multivector MLP with geometric bilinear interactions, and another residual connection. The architecture is adapted to correctly handle multivector data and be E(3) equivariant. These various components are discussed in more detail when FIG. 3 is introduced below.

The GATr network 212 is a general-purpose network architecture for geometric data. Input data 202 can be received from any three-dimensional context such as an image, a point cloud, a video, and/or other data related to a task in three-dimensions. A pre-processing engine 204 processes the data to generate geometric types 206. The pre-processing may or may not be necessary depending on the structure of the raw inputs. In some aspects, the pre-processing engine 204 can parse pixels of images from one or more cameras into positions and velocities of one or more objects in the images. Additionally or alternatively, the pre-processing engine 204 can process locations of objects, orientation of objects, and/or a direction of movement of objects in a three-dimensional space.

A geometric algebra embedding engine 208 can generate multivector inputs 210 (also referred to as multivectors) using the geometric types 206. For example, the geometric algebra embedding engine 208 can embed the geometric types 206 (e.g., the geometric properties of the input data) into multivector representations of the multivector inputs 210. In some aspects, the multivector inputs 210 can be generated from a geometric product of vectors. Additionally or alternatively, the multivector inputs 210 can be a representation of geometric objects and operators associated with the geometric objects. In some aspects, the geometric algebra embedding engine 208 can embed the geometric objects into multivectors of geometric algebra [symbol] _{3,0,1}, which can result in the multivector inputs 210.

The GATr network 212 can receive the multivector inputs 210. Based on performing equivariant processing of the geometric algebra representations embodied in the multivector inputs 210, GATr network 212 can generate multivector outputs 214. An extraction engine 216 can extract geometric objects (e.g., based on geometric algebra) from the multivector outputs 214 to obtain a final output 218. The final output 218 can be used to perform a task, such as control movement of a robotic component (e.g., a robotic arm).

In some cases, the multivector outputs 214 can include data such as an orientation and/or a movement of a robotic arm. In one example, the input data 202 can include multiple camera images which can be used to identify a current position of a robotic arm, a block, a location of the block and a location where the block needs to be moved. The multivector outputs 214 may include data regarding an orientation or a movement of the robotic arm (such as through a vector or a direction of movement) in order to achieve the task. The neural network model 200 can extract features or other information from the multivector outputs 214 to perform the task. For example, in a reinforcement learning situation, the system can extract a next action from the multivector outputs 214. In another example, in the event the problem being addressed by the neural network model 200 is a regression problem, the neural network model 200 can extract a subject of the regression problem.

In some aspects, the task is to stack a set of blocks. The input data 202 data can identify a current position of a robotic arm and a current position of four blocks on a table. The output 214 may include how the robotic arm needs to move to grab one block at a time and stack the blocks. The output 214 represents the movement for the robot and may include data types not found in the input, such as vectors that represent a rotational value or a translation value associated with the movement the robot needs to achieve to stack the blocks or perform the task.

The design of GATr network 212 follows from various design principles. One principle is a geometric inductive bias through geometric algebra representations. The GATr network 212 can be designed to provide a strong inductive bias for geometric data. The GATr network 212 should be able to represent different geometric objects and their transformations, for instance points, lines, planes, translations, rotations, and so on. In addition, the GATr network 212 should be able to represent common interactions between these types with few layers, and be able to identify them from little data (while maintaining the low bias of large transformer models). Examples of such common patterns include computing the relative distances between points, applying transformations to objects, or computing the intersections of planes and lines.

This disclosure proposes that geometric algebra provide a language that is well-suited to a task. One can use the projective geometric algebra [symbol] _{3,0,1} and use the plane-based representation of geometric structure outlined above.

Another design principle is symmetry awareness through E(3) equivariance. The architecture of the GATr network 212 should respect the symmetries of 3D space. Therefore, the GATr network 212 is equivariant with respect to the symmetry group E(3) of translations, rotations, and reflections.

Note that the projective geometric algebra naturally offers a faithful representation of E(3), including translations. One can thus represent objects that transform arbitrarily under E(3), including with respect to translations of the inputs. This is in stark contrast with most E(3)-equivariant architectures, which only use O(3) representations and whose features only transform under rotation. Those architectures must handle points and translations in hand-crafted ways, like by canonicalizing with respect to the center of mass or by treating the difference between points as a translation-invariant vector.

Many systems will not exhibit the full E(3) symmetry group. The direction of gravity, for instance, often breaks it down to the smaller E(2) group. To maximize the versatility of the GATr network 212, one can choose to develop a E(3)-equivariant architecture and to include symmetry-breaking as part of the network inputs, similar to how position embeddings break permutation equivariance in transformers.

Another design principle is scalability and flexibility through dot-product attention. The GATr network 212 can be expressive, easy to train, efficient, and scalable to large systems. The GATr network 212 should also be as flexible as possible, supporting variable geometric inputs and both static scenes and time series.

These design principles can cause one to implement the GATr network 212 as a transformer, based on attention over multiple objects (similar to tokens in a multilayer perceptron (MLP) or image patches in computer vision). The choice of using a transformer makes the GATr network 212 equivariant also with respect to permutations along the object dimension. As in standard transformers, one can break this equivariance when desired (in particular, along time dimensions) through positional embedding.

The GATr network 212 can be based on a dot-product attention mechanism, for which heavily optimized implementations exist. The GATr network 212 can be scaled to problems with many thousands of tokens, much further than equivariant architectures based on graph neural networks and message-passing algorithms.

In some aspects, a multilayer perceptron (MLP) is a fully connected class of feedforward artificial neural network (ANN). The term MLP can mean any feedforward ANN. In other cases, MLP can strictly refer to networks composed of multiple layers of perceptrons (with threshold activation). MLPs are sometimes referred to as “vanilla” neural networks, especially when they have a single hidden layer.

An MLP can include at least three layers of nodes: an input layer, a hidden layer and an output layer. Except for the input nodes, each node is a neuron that uses a nonlinear activation function. MLPs can utilize a chain rule based supervised learning technique called backpropagation or reverse mode of automatic differentiation for training. Its multiple layers and non-linear activation distinguish MLP from a linear perceptron. It can distinguish data that is not linearly separable.

FIG. 3 illustrates an example of an architecture 300 of a GATr network 312. Note that within FIG. 2 and FIG. 3, boxes with solid lines are learnable components. Boxes with dashed lines are fixed components. As shown, the architecture 300 includes of the GATr network 312 includes components, including an input equilinear layer 302 and N transformer blocks 304. Each of the N transformer blocks 304 includes a first normalization layer 306 (e.g., a first equivariant multivector normalization layer, which may be implemented as a LayerNorm), a first equilinear layer 308, a geometric attention layer 310 (e.g., an equivariant multivector self-attention layer), a first geometric product engine 313 (or layer), a second equilinear layer 314, a first addition engine 316 (e.g., a first residual connection), a second normalization layer 318 (e.g., a second equivariant multivector normalization layer, which may be implemented as a LayerNorm), a third equilinear layer 320, a second geometric product engine 322 (or layer), a scalar-gated nonlinearity layer 324, a fourth equilinear layer 326, and a second addition engine 328 (e.g., a second residual connection). In some cases, the various components may be used in a typical transformer with pre-layer normalization, and may be adapted to handle multivector data and be E(3) equivariant as described herein. In some aspects, one or more of the first normalization layer 306, the first geometric product engine 313, the first addition engine 316, the second normalization layer 318, the second geometric product engine 322, the scalar-gated nonlinearity layer 324, and the second addition engine 328 may be fixed components. In some aspects, one or more of the first equilinear layer 308, the geometric attention layer 310, the second equilinear layer 314, the third equilinear layer 320 and the fourth equilinear layer 326 can be learnable components.

As described previously, the GATr network 312 can process a multivector input (e.g., multivector inputs 210 of FIG. 2), such as multivector-valued data (e.g., similar to the GATr network 212 of FIG. 2). Based on the output from the GATr network 312, the architecture 300 can extract geometric objects of interest (e.g., geometric objects of interest extracted by the extraction engine 216 of FIG. 2). For example, according to some aspects, the input equilinear layer 302 can receive and process multivector inputs (e.g., the multivector inputs 210 of FIG. 2) and can generate an input equilinear layer output. The input equilinear layer output can be provided to a transformer block from the N transformer blocks 304. The first normalization layer 306 in the transformer block receives the input equilinear layer output and generates a first normalization layer output. The first equilinear layer 308 in the transformer block 304 receives the first normalization layer output and generates a first equilinear layer output. The geometric attention layer 310 receives the first equilinear layer output and generates a geometric attention layer output. The first geometric product engine 313 receives the geometric attention layer output and the first equilinear layer output and generates a first geometric product engine output. The second equilinear layer 314 receives the first geometric product engine output and generates a second equilinear layer output. The first addition engine 316 adds the second equilinear layer output to the input equilinear layer output to generate a first addition output or first addition output.

The second normalization layer 318 receives the first addition output or first addition output and generates a second normalization layer output. The third equilinear layer 320 receives the second normalization layer output and generates a third equilinear layer output. The second geometric product engine 322 receives the third equilinear layer output and generates a second geometric product engine output. The scalar-gated nonlinearity layer 324 receives the second geometric product engine output and generates a scalar-gated nonlinearity layer output. The fourth equilinear layer 326 receives the scalar-gated nonlinearity layer output and generates a fourth equilinear layer output. The second addition engine 328 adds the fourth equilinear layer output to the first addition output to generate a second addition output. The output equilinear layer 330 receives the second addition output and can then generate multivector outputs (e.g., multivector outputs 214 of FIG. 2).

Various primitives can be used for the GATr network (e.g., the GATr network 212 of FIG. 2 and/or the GATr network 312 of FIG. 3. In some cases, linear layers between multivectors can be used. The equivariance condition of Eq. (3) can constrain the linear layers. For example, a linear map φ: [symbol] _{d,0,1}→ [symbol] _{d,0,1} that is equivariant to Pin(d, 0, 1) can be in the following form:

$$ϕ ( x ) = {\sum }_{k = 0}^{d + 1} {w}_{k} {〈 x 〉}_{k} + {\sum }_{k = 0}^{d} {v}_{k} {e}_{0} {〈 x 〉}_{k} \qquad ( 4 )$$

for parameters w∈ [symbol] , v∈ [symbol] . Here (x)ₖ is the blade projection of a multivector, which sets all non-grade-k elements to zero.

According to Equation (4), E(3)-equivariant linear maps between [symbol] _{3,0,1} multivectors can be parameterized with nine coefficients, five of which are the grade projections and four include a multiplication with the homogeneous basis vector e₀. One can thus parameterize affine layers between multivector-valued arrays with Eq. (4), with learnable coefficients wₖ and vₖ for each combination of input channel and output channel. In addition, there is a learnable bias term for the scalar components of the outputs (biases for the other components are not equivariant). While the number of coefficients in one aspect is nine, other numbers of coefficients can be used as well.

Geometric bilinears can also be used for the GATr network. For instance, equivariant linear maps are not sufficient to build expressive networks. The reason is that these operations allow for only very limited grade mixing, as shown above. For the GATr network to be able to construct new geometric features from existing features, such as the translation vector between two points, additional primitives (e.g., geometric primitives) can be utilized. For example, a first primitive that can be used the GATr network includes a geometric product x, y [symbol] xy, which is a bilinear operation of geometric algebra. The geometric product allows for substantial mixing between grades. For instance, the geometric product of vectors includes scalars and bivector components. The geometric product is equivariant. A second primitive that can be used by the GATr network can be derived from the so-called join x, y [symbol] (x*∧y*)*. The join operation has an anti-dual (not a dual) in the output. The GATr network, for equivariance purposes and for expressivity, can utilize either the anti-dual or dual output, as any equivariant linear layer can transform between the two. A resulting equivariant map can thus include the dual x [symbol] x*. Including the dual in an architecture of the GATr network can be useful for expressivity: in [symbol] _{3,0,1}. For example, without dualization, it may not be possible to represent even simple functions such as the Euclidean distance between two points. While the dual itself is not Pin(3,0, 1)-equivariant (with respect to ρ), the join operation is equivariant to even (non-mirror) transformations. To make the join equivariant to mirrorings as well, one can multiply its output with a pseudoscalar derived from the network inputs: x, y, z [symbol] EquiJoin(x, y; z)=z₀₁₂₃(x*∧y*)*, where z₀₁₂₃∈ [symbol] is the pseudoscalar component of a reference multivector z.

A geometric bilinear layer can be used that combines the geometric product and the join of the two inputs as Geometric(x,y;z)=Concatenate_{channels} (xy, EquiJoin(x,y;z)). In the GATr network, the layer is included in the MLP.

The GATr network can include various nonlinearities and normalization operations. In some aspects, scalar-gated Gaussian Error Linear Unit (GELU) nonlinearities GatedGELU(x)=GELU(x₁)x, can be used, where x₁ is the scalar component of the multivector x. Moreover, an E(3)-equivariant LayerNorm operation can be defined for multivectors as LayerNorm (x)=x/\sqrt{ [symbol]_{c} [symbol] x, x [symbol]}, where the expectation goes over channels and one can use the invariant inner product [symbol] ‘,’ [symbol] of [symbol] _{3,0,1}.

The GATr network also uses attention in one or more layers. In some aspects, given multivector-valued query, key, and value tensors, each including nᵢ items (or tokens) and n_{c} channels (key length), the E(3)-equivariant multivector attention can be defined, for example as follows:

$${Attention ( q , k , v )}_{{i}^{′} {c}^{′}} = {\sum }_{i} {Softmax}_{i} ( \frac{{\sum }_{c} 〈 {q}_{{i}^{′} c} , {k}_{i c} 〉}{\sqrt{8 {n}_{c}}} ) {v}_{i {c}^{′}} . \qquad ( 5 )$$

Here, the indices i, iⁱ label items, c, cⁱ label channels, and [symbol] ‘,’ [symbol] is the invariant inner product of the geometric algebra. The approach disclosed herein computes scalar attention weights with a scaled dot product. The difference is that one can use the inner product of [symbol] _{3,0,1}. One can also use attention mechanisms that apply the geometric product rather than the dot product. Since this dot product of [symbol] _{3,0,1} only depends on 8 out of 16 multivector dimensions, one can scale the inner product by \sqrt{8n_{c}} rather than \sqrt{16n_{c}} as one would do in a conventional transformer with key dimension dₖ=16n_{c}. Despite this difference, one can build on highly efficient implementations of dot-product attention. As can be demonstrated, the approach allows us to scale the GATr network to systems with many thousands of tokens. One can extend this attention mechanism to multi-head self-attention in the usual way.

In some cases, auxiliary scalar representations (e.g., in addition to multivector representations) can be used. For instance, while multivectors can be well-suited to model geometric data, many problems contain non-geometric information as well. Such scalar information may be high-dimensional, for instance in sinusoidal positional encoding schemes. Rather than embedding into the scalar components of the multivectors, one can add an auxiliary scalar representation to the hidden states of the GATr network. Each layer thus has both scalar and multivector inputs and outputs. The layers have the same batch dimension and item dimension, but may have different number of channels.

The additional scalar information may interact with the multivector data in various ways. In linear layers, the GATr network can be designed so that auxiliary scalars mix with the scalar component of the multivectors. An attention layer of the GATr network (e.g., the geometric attention layer 310 of FIG. 3) can compute attention weights from the multivectors (e.g., as given in Eq. (5)) and from the auxiliary scalars (e.g., using scaled dot-product attention, such as by the first geometric product engine 313 of FIG. 3), resulting in two attention maps. The two attention maps can be summed (e.g., by the first addition engine 316 of FIG. 3) before performing normalization (e.g., by the second normalization layer 318 and/or third equilinear layer 320 of FIG. 3), such as using Softmax. In some cases, a normalizing factor of the normalization is adapted. In other layers of the GATr network, the scalar information can be processed separately from the multivector information, using the unrestricted form of the multivector map. For instance, nonlinearities can transform multivectors with equivariant gated GELUs and auxiliary scalars with regular GELU functions.

As noted above, in addition to multivector representations, GATr supports auxiliary scalar representations. For instance, GATr can use auxiliary scalar representations to describe non-geometric side information such as positional encodings or diffusion time embeddings. In some layers (e.g., most layers) of the GATr neural network architecture, the scalar variables can be processed as in a standard transformer, with two exceptions. For some examples, as noted above, the scalar components of multivectors and the auxiliary scalars are allowed to freely mix in the linear layers. In such examples, In the attention operation, the attention weights can be computed as follows:

$${Softmax}_{i} ( \frac{{\sum }_{c} 〈 {q}_{{i}^{′} c}^{M V} , {k}_{i c}^{M V} 〉 + {\sum }_{c} {q}_{{i}^{′} c}^{s} {k}_{i c}^{s}}{\sqrt{8 {n}_{M V} + {n}_{s}}} ) \qquad ( 6 )$$

where q^{MV} and k^{MV} are query and key multivector representations, respectively, q^{s} and k^{s} are query and key scalar representations, respectively, n_{MV} is the number of multivector channels, and nₛ is the number of scalar channels.

The distance-aware dot-product attention is discussed next. The dot-product attention in Eq. (5) takes into account only half of the components of the multivectors (including those that do not involve the basis element e₀), as a straightforward Euclidean inner product with those components would violate equivariance. One can, however, extend the attention mechanism to incorporate more components, while still maintaining E(3) equivariance and the computational efficiency of dot-product attention. For instance, queries and keys can be extended with nonlinear features. To this end, one can define certain auxiliary, non-linear query features φ(q) and key features ψ(k) and extend the attention weights in Eq. (5) as [symbol] q_{i′c}, k_{ic} [symbol] → [symbol] q_{i′c}, k_{ic} [symbol] +φ(q_{i′c})·ψ(k_{ic}), adapting the normalization appropriately.

For example, to extend queries and keys with nonlinear features the following can be used:

$$ϕ ( q ) = \frac{{q}_{\backslash 0}}{{q}_{\backslash 0}^{2} + ϵ} ( \begin{matrix}{q}_{\backslash 0}^{2} \\ {\sum }_{i} {q}_{\backslash i}^{2} \\ {q}_{\backslash 0} {q}_{\backslash 1} \\ {q}_{\backslash 0} {q}_{\backslash 2} \\ {q}_{\backslash 0} {q}_{\backslash 3}\end{matrix} ) and ψ ( k ) = \frac{{k}_{\backslash 0}}{{k}_{\backslash 0}^{2} + ϵ} ( \begin{matrix}- {\sum }_{i} {k}_{\backslash i}^{2} \\ - {k}_{\backslash 0}^{2} \\ 2 {k}_{\backslash 0} {k}_{\backslash 1} \\ 2 {k}_{\backslash 0} {k}_{\backslash 2} \\ 2 {k}_{\backslash 0} {k}_{\backslash 3}\end{matrix} ) \qquad ( 7 )$$

where the index \i denotes the trivector component with all indices but i. The following can then be determined:

$$ϕ ( {q}_{{i}^{′} c} ) \cdot ψ ( {k}_{i c} ) ∝ - {( {k}_{∖ 0} \vec{q} - {q}_{∖ 0} \vec{k} )}^{2} \qquad ( 8 )$$

where the following shorthand is used: \vec{x}=(x_{\1}, x_{\2}, x_{\3})^{T}.

This additional contribution to the attention weights is E(3)-invariant. When the trivector components of queries and keys represent 3D points, it becomes proportional to the pairwise negative squared Euclidean distance between the points. With the additional contribution, the attention mechanism of GATr computes attention weights from three sources, including the [symbol] _{3,0,1} inner product of the multivector queries and keys [symbol] q, k [symbol] , the distance-aware inner product of the nonlinear features φ(q)·ψ(k), and the Euclidean inner product of the auxiliary scalars qₛ·kₛ. In some cases, it can be beneficial to add learnable weights as prefactors to each of the three terms. The attention weights can then be given by the following:

$${Softmax}_{i} ( \frac{α {\sum }_{c} 〈 {q}_{{i}^{′} c}^{M V} , {k}_{i c}^{M V} 〉 + β {\sum }_{c} ϕ ( {q}_{{i}^{′} c}^{M V} ) \cdot ψ ( {k}_{i c}^{M V} ) + γ {\sum }_{c} {q}_{{i}^{′} c}^{s} {k}_{i c}^{s}}{\sqrt{13 {n}_{M V} + {n}_{s}}} ) \qquad ( 9 )$$

with learnable, head-specific α, β, γ>0. All terms in equation (9) can be summarized in a single Euclidean dot product between query features and key features. Efficient implementations of dot product attention to compute GATr attention. In some cases, to reduce memory use, a version of GATr that uses multi-query attention can be used instead of multi-head attention, sharing the keys and values among attention heads.

In some cases, machine learning models, such as traditional machine learning (ML) models, as well as GATr, may be used to process 3D data, such as point clouds, 3D meshes, and the like, for example, for simulations, predicting temporal dynamics, radio frequency propagation, transmitter/receiver localization, 3D reconstruction, and the like. As ML models become more capable of processing data, such as 3D data, ML models may be applied to larger and/or more complex sets of data. For example, scientific 3D meshes for medical research may include hundreds of thousands or millions of vertices and/or triangles. Additionally, some meshes, such as cortical surface meshes may model folds and/or wrinkles of brain surfaces and may have a heterogeneous point cloud and/or vertices/triangle density to account for such folds that cannot be easily discretized and/or downsampled. As another example, ML models may be used to process models simulating large-scale environments, such as over a whole town or city, etc., to determine, for example, transmitter/receiver locations, predict coverage, etc., that also cannot be easily discretized and/or downsampled.

As noted above, certain ML models, such as GATr, can include transformers and process tokens. As transformers are scaled to process increasingly large and/or complex data sets, transformers may start to suffer from quadratic scaling complexity where the runtime scales proportional to a square of the input size (e.g., token size), potentially resulting in large increases in computational costs and computational resources as input data increases. For example, transformer-based models may discretize input data into tokens and the transformer may determine relationships among these tokens. However, large datasets that are difficult to discretize may be problematic. Difficulty in discretizing may refer to a number of tokens used to describe the input data, where increased difficult in discretizing may refer to an increased number of tokens that may be used to describe the input. For example, a cortical surface mesh may be more dense (e.g., with respect to points, vertices, triangles, etc.) in folded/wrinkled areas, as compared to smoother surfaces, and as a relatively large number tokens may be used to describe the more complex folded/wrinkled areas, and these tokens may not be easily combined with other tokens describing the smoother surfaces. As different discretization may be used for the different surfaces of the cortical surface mesh, the number of tokens that may be used to discretize such data may increase. As transformers may use attention to pair tokens with each other, increasing the number of tokens can dramatically increase runtimes.

In accordance with aspects of the present disclosure, virtual tokens may be used along with virtual nodes to help transformers scale for a larger number of tokens. For example, rather than operating on a set of N tokens, a set of V virtual nodes may generate a set of V virtual tokens. In some cases, the set of V virtual nodes may be initialized with learnable features and the set of V virtual nodes and V virtual tokens may be independent of the input. The virtual tokens may interact with each other via the GATr backend (e.g., via an attention layer that allows interactions between the virtual tokens) and the virtual nodes may attend to the input N tokens to detangle the V virtual nodes from the discretization of the N tokens. The transformer architecture may then operate on the V virtual tokens with a complexity of O(V²). The virtual tokens may be combined with the input N tokens via cross-attention with a complexity of O(NV). A majority of the transformer layers may operate on virtual tokens and information from the virtual tokens can be decoded into output tokens (which may be the same number N as the set of input tokens) for an overall complexity of O(V²+NV). Using virtual tokens and virtual nodes may help computational costs scale linearly with the number of input tokens N and the computational capacity can be disentangled from input tokenization/discretization. In some cases, computational capacity may refer to expressivity of the ML model. The computational capacity may depend on the number of virtual nodes V rather than the number of the input data N, and V may be a controllable hyperparameter of the ML model. In some cases, the number N depends on the input data (e.g. number of vertices in cortical surface meshes) and cannot be easily adapted. The number V can be freely chosen (as long as it is a multiple of the number of ambiguous PCA eigenbases, which in 3D is four). In some cases, the number V influences the attainable accuracy (e.g., higher V/increases performance). In practice, V may be set low enough to fit the computational budget and high enough to provide a powerful enough model.

In some cases, geometric data may have certain symmetries such that a geometric transformation on the geometric data, such as a rotation, reflection, translation, etc., may be reflected in predictable ways in the geometric data. These symmetries may help enable efficient learning and an equivariant architecture may incorporate these symmetries. As discussed above, GATr may be equivariant with respect to E(3), the symmetry group of three-dimensional space such that if the input is rotated/reflected/translated, the output of GATr may also be rotated/reflected/translated in accordance with the input. In some cases, a straight-forward implementation of virtual tokens and virtual nodes may break such equivariance and the benefits of an equivariant architectures may be lost. To maintain equivariance, virtual nodes should transform equivariantly to the input tokens so that if the set of N input tokens are transformed in a certain way, the virtual tokens should be transformed in that way as well. Thus, virtual tokens should be disentangled from the input tokens while still carrying the geometric information of the input tokens and transformed in the same way. In some cases, GATr may operate on scalar features and/or another type of invariant feature. For example, the pre-processing engine 204 of FIG. 2 may generate scalar features and/or invariant features as vectors on which GATr may process. The features of GATr may be invariant such that, for example, if an object in the input data is rotated/translated/reflected, the features of the vector may change to express the rotation/translation/reflection of the object. These features may be represented in the multivector inputs (e.g., multivector inputs 210 of FIG. 2). In some cases, the multivector may be able to represent objects, such as lines, planes, volumes, points, etc., as well as possible geometric operations on such objects.

To maintain equivariance, the virtual nodes may be initialized with learnable, invariant, scalar features. For example, information generated from input data, such as multivectors, point clouds, vertices, etc., may be embedded into the virtual nodes. A principal component analysis (PCA) may be performed on the input tokens to obtain geometric features. The PCA may be a either a singular value decomposition applied to a matrix of, for example, a point cloud, or an eigenvalue decomposition applied to a covariance matrix. For example, the PCA may be performed by determining a mean of the point cloud (e.g., a center of mass of the point cloud) and subtracting the mean from the values of point cloud and dividing by the standard deviation to standardize the range of the values. A covariance matrix may then be determined based on the standardized values. Eigenvectors (e.g., principal components) and eigenvalues of the covariance matrix may be determined, and a feature vector of the eigenvectors generated. In some cases, the feature vector may include three eigenvectors.

In some cases, the center of mass (e.g., mean of the point cloud) may be thought of as a point and if the points of the point cloud are transformed, the center of mass may also be transformed. For example, if the point cloud is translated, the center of mass will also be translated. In some cases, the eigenvectors (e.g., principal components) may be thought of as translation operations of the center of mass.

For example, given N input token positions X∈ [symbol] , where [symbol] is a matrix of shape 3 by N and where each column of [symbol] represents coordinates of an input point, the PCA of X may generate three orthonormal principal component vectors W=[wₓ, w_{y}, w_{z}], wₓ∈ [symbol] along with three singular value associated with these principal components wₓ, w_{y}, w_{z}. The results of the PCA may be equivariant such that W=PCA(X)⇒RW=PCA(RX+t) for R∈0(3) and t∈ [symbol] , where t comprises a translation and R comprises a rotation. In some cases, PCA analysis may result in sign ambiguity where a sign of the principal components may be unknown. Considering all possible sign combinations of the principal components results in 8 possible matrices versions of W. Of the 8 possible matrices, 4 matrices have a positive determinant (e.g., represent right-handed frames with a determinant=1), and these 4 combinations may be selected such that 4 frames

$${\{ {W}_{j} \}}_{j = 0}^{3} ,$$

can be defined. The determinant may be a scalar-valued function of the entries of a matrix. Virtual nodes may learn from the four frames. For example, given V virtual nodes, the virtual nodes may be split based on the four frame such that each there are V/4 virtual nodes associated with each frame. The frames may be embedded into the virtual nodes such that for a virtual node (i,j), where

$$i ∈ [ 0 , … , \frac{V}{4} ]$$

and j∈{0, 1, 2, 3}, yᵢⱼ=Wⱼsᵢ+o, where o may be the center of mass of X, sᵢ may be an i-th learnable scalar feature vector, shared by the virtual nodes

$${\{ ( i , j ) \}}_{j = 0}^{3} ,$$

Wⱼ may be a j-th right handed frame (e.g., a weight of the principal components by square root of singular values), and yᵢⱼ may be a coordinate vector of virtual node (i, j). As there may not be a way to canonically order the right-handed frames apart, this 4-fold permutation symmetry handled by an attention mechanism of GATr which is equivariant to permutations. The virtual nodes may learn a set of scalar 3D features (e.g., sᵢ) that are invariant coordinates of the virtual nodes and these invariant coordinates may be combined with a variant of the four frames (e.g., Wⱼ) to obtain a new 3D coordinate. This new 3D coordinate may be shifted based on the center of mass o as the coordinate vector yᵢⱼ of the virtual node. The new 3D coordinates of the virtual node with embedded PCA information may be equivariant under rotation, translation, and translation.

In some cases, embedding virtual nodes with the PCA information may be performed by GATr. For example, two linear and bilinear layers of GATr generating two bilinear tensor products can combine scalar and geometric features from the PCA (e.g., center of mass and principal components) to reconstruct a point cloud (or generate virtual tokens describing such a point cloud) with equivalent coordinates that can rotate and shift corresponding to the input tokens. Virtual tokens can be generated to describe this reconstructed point cloud. As a more specific example, the Wⱼsᵢ vector (e.g., Wⱼ)—scalar (e.g., sᵢ) product operation may be performed by a single bilinear layer and linear combination of vectors by a single equivariant linear layer. The translation by the center of mass o by tᵢⱼ=wⱼsᵢ may be performed with another bilinear layer. The vector-scalar product operation and translation may be performed without using, and prior to, an attention mechanism. GATr may then be trained to reconstruct an equivalent point cloud based on the PCA information. Multiple heads may be included to perform multiple attentions in parallel using the equivalent point cloud or other information.

Therefore, the PCA information may be input to GATr as features and GATr may learn how to combine the scalar and geometric features and learn the equivalent point cloud and rotations thereof, as well as other features. The PCA information may be used to initialize the virtual nodes and the virtual nodes may learn aspects of the input features akin to a downsampling of the original point cloud data using GATr. GATr may then be able to processes additional data (e.g., additional point cloud data) using the trained virtual nodes. In some cases, the virtual node can be trained to focus on different subsets of the input points near the coordinates of the virtual nodes using distance-aware attention and positional bias, for example, using the attention mechanism.

As the virtual nodes of a ML model (e.g., GATr-based model) may learn an E(3) equivariant version of the geometric data, the ML model may use less memory and execute faster as compared to other ML models for a given number of input tokens.

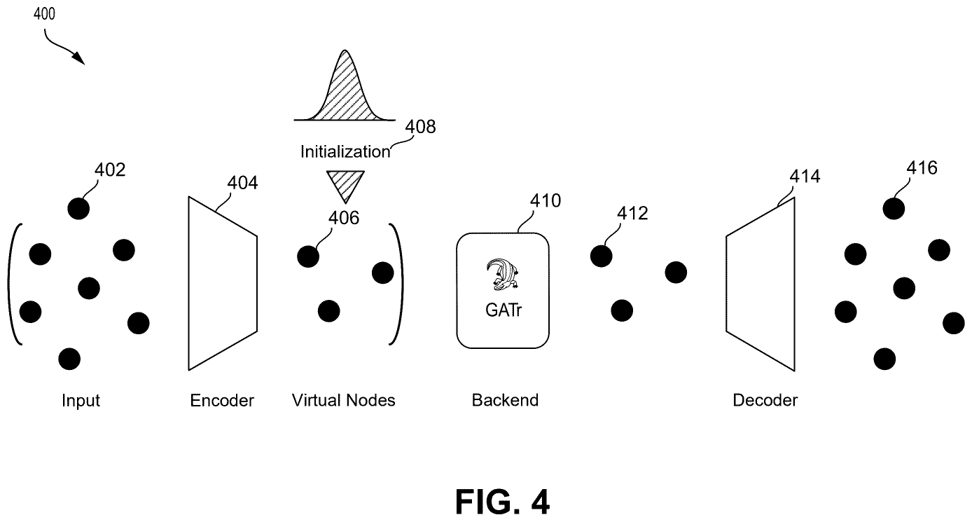

FIG. 4 is a conceptual diagram of a ML model 400 based on a GATr network using virtual nodes embeddings, in accordance with aspects of the present disclosure. As shown, input data of size N to be processed by the ML model may be described using a relatively larger set of input tokens 402 V, such that N>V. While input tokens 402 is used in this example, it should be understood that the input to the ML model 400 is not limited to tokens and any form of representation for input datum may be used. An initialization 408 process may be used to prepare a set of virtual nodes 406. In some cases, the initialization 408 may perform a PCA operation, as described above, on the input tokens 402 to embed aspects of the input tokens 402 to the virtual nodes 406. In some cases, one or more portions of a GATr network 410 may be used to embed may be used aspects of the input tokens 402 to the virtual nodes 406, as described above. The virtual nodes may be randomly initialized prior to learning/training. The virtual nodes may also be trained using target data labels (e.g., labeled input data), and the virtual nodes may be trained in a manner similar to learning for other parameters in a ML model. The input tokens 402 may be encoded using an encoder 404 into the set of virtual nodes 406. In some cases, the encoder 404 may encode features of the input tokens into the virtual nodes 406. In some cases, the encoder 404 may apply cross-attention to the input tokens 402 to relate features of the input tokens 402 to the virtual nodes 406.

After encoding by the encoder 404, the virtual nodes 406 may be passed to a the GATr network 410. In some cases, the GATr network 410 may be substantially similar to GATr network 312 of FIG. 3. The GATr network 410 may generate a set of output virtual tokens 412 and the set of output virtual tokens 412 may be passed to a decoder 414. The decoder 414 may map the output virtual tokens 412 to a set of output tokens 416 corresponding to the input tokens 402. In some cases, the decoder 414 may be an inverse of the encoder 404. For example, the decoder 414 may perform cross attention or attention layer on the output virtual tokens 412 to interpolate the virtual tokens to the set of output tokens 416. In some cases, the cross-attention may be used to evaluate Q query points using the V virtual nodes as keys and values to obtain Q result tokens where Q>V typically. In some cases, Q may be equal to the number of input tokens.

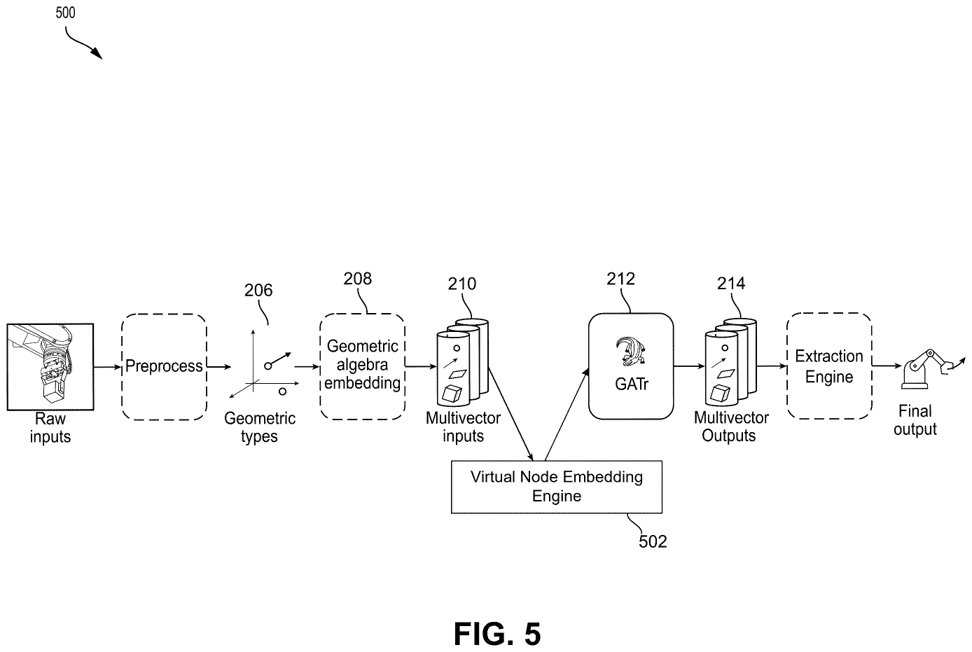

FIG. 5 illustrates a neural network model 500 that includes various components including an example of a GATr network 212 using virtual nodes embeddings, in accordance with aspects of the present disclosure. FIG. 5 is based on FIG. 2 and numbered elements of FIG. 5 may be substantially similar to like numbered elements of FIG. 2. As shown in FIG. 5, and discussed above with respect to FIG. 2, a geometric algebra embedding engine 208 can generate multivector inputs 210 (also referred to as multivectors) using the geometric types 206. These multivector inputs 210 may be used by a virtual node embedding engine 502 to initialize a set of virtual nodes based on the multivector inputs 210. For example, as discussed above, information for the multivector inputs 210, such as a center of mass and set of eigenvectors, may be determined (e.g., via PCA). The multivector inputs 210 may then be embedded in the set of virtual nodes, for example, via encoder 404 of FIG. 4. The resulting virtual tokens may be output by the virtual node embedding engine 502 to the GATr network 212 and the GATr network 212 may generate the multivector outputs 214 based on the virtual tokens output by the virtual nodes in a manner substantially similar to that discussed above with respect to FIG. 3.

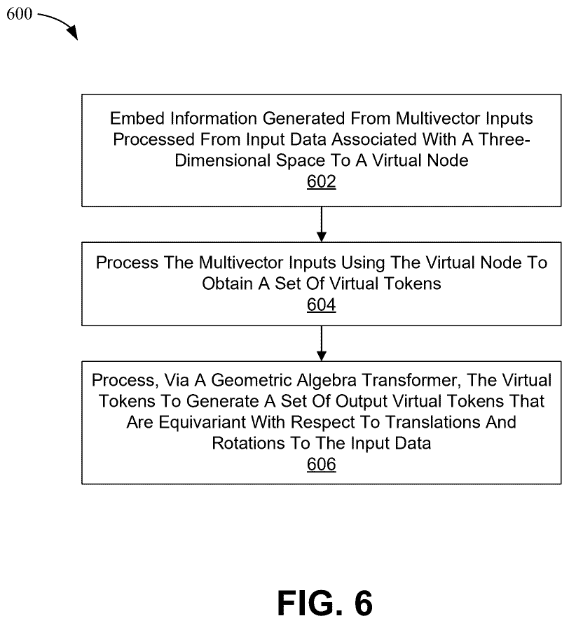

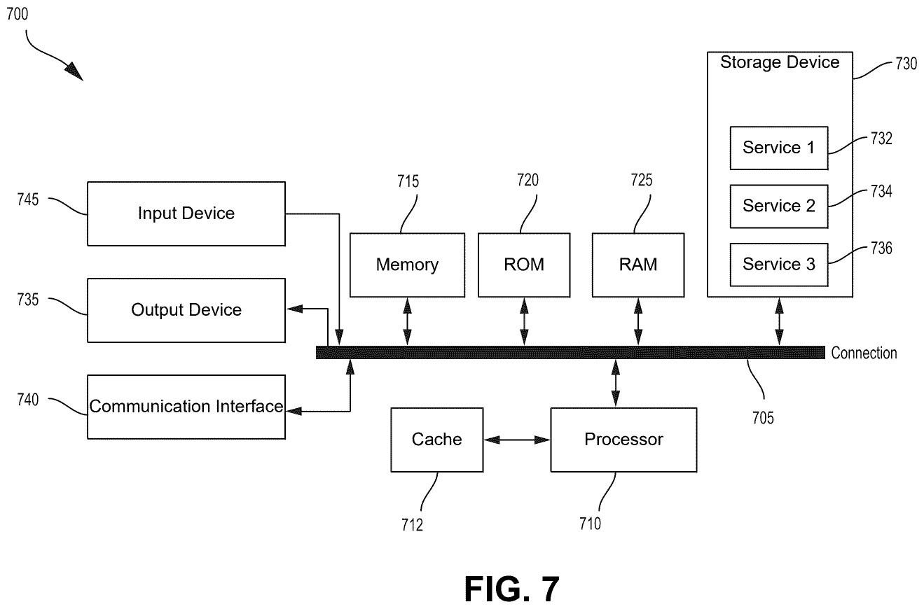

FIG. 6 is a flow diagram illustrating a process 600 for data privacy, in accordance with aspects of the present disclosure. The process 600 may be performed by a computing device (or apparatus) (e.g., computing device 700 of FIG. 7) or a component (e.g., a chipset, neural network model 200, neural network model 500, processor 710 of FIG. 7, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 600 may be implemented as software components that are executed and run on one or more processors.

At block 602, the computing device (or component thereof) may embed information generated from multivector inputs (e.g., multivector inputs 210 of FIG. 2) processed from input data (e.g., input data 202 of FIG. 2) associated with a three-dimensional space to a virtual node (e.g., of a set of virtual nodes 406 of FIG. 4). In some cases, the information generated comprise a center of mass and a set of eigenvectors. In some examples, the center of mass and the set of eigenvectors are generated as a part of a principal component analysis (PCA). In some cases, embedding the information generated from multivector inputs is performed based on all possible sign combinations of eigenvectors, from the set of eigenvectors, generated as a part of the PCA. For example, PCA analysis may result in sign ambiguity and different combinations of possible signs may be considered. In some cases, eigenvectors with a positive determinant may be used and other eigenvectors may be removed. In some examples, the computing device (or component thereof) may determine the eigenvectors with a positive determinant from the set of eigenvectors, where the embedding is performed using the eigenvectors with positive determinants. In some cases, embedding the information generated from multivector inputs is performed using portions of the geometric algebra transformer. In some examples, the portions of the geometric algebra transformer comprise two bilinear layers and an equivariant layer.

At block 604, the computing device (or component thereof) may process the multivector inputs using the virtual node to obtain a set of virtual tokens. In some cases, the virtual tokens may be virtual nodes combined with the input data.

At block 606, the computing device (or component thereof) may process, via a geometric algebra transformer (e.g., GATr network 212 of FIG. 2, GATr network 312 of FIG. 3, GATr network 410 of FIG. 4) the set of virtual tokens to generate a set of output virtual tokens (e.g., set of output virtual tokens 412 of FIG. 4) that are equivariant with respect to translations and rotations to the input data. In some cases, the computing device (or component thereof) may decode (e.g., via decoder 414 of FIG. 4) the set of output virtual tokens to obtain a set of output tokens (e.g., set of output tokens 416) for output. For example, the decoder may perform cross attention or attention layer on the output virtual tokens to interpolate the virtual tokens to the set of output tokens. In some cases, the set of output virtual tokens are decoded using a cross-attention layer. In some examples, the geometric algebra transformer further comprises at least: an input equilinear layer (e.g., input equilinear layer 302 of FIG. 3); a geometric attention layer (e.g., geometric attention layer 310 of FIG. 3); and an output equilinear layer (e.g., output equilinear layer 330 of FIG. 3).

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600 and/or other processes described herein may include a processor, microprocessor, micro-computer, or other component of a device that is configured to carry out the steps of the process 600 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 600 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 600 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

In some aspects, training of one or more of the machine learning systems or neural networks described herein (e.g., such as the neural network model 200 of FIG. 2, the GATr network 312 of FIG. 3, encoder 404 of FIG. 4, set of virtual nodes 406 of FIG. 4, GATr network 410 of FIG. 4, decoder 414 of FIG. 4, neural network model 500 of FIG. 5, among various other machine learning networks described herein) can be performed using online training (e.g., in some case on-device training), offline training, and/or various combinations of online and offline training. In some cases, online may refer to time periods during which the input data (e.g., such as the input data 202 of FIG. 2, the input tokens 402 of FIG. 4, etc.) is processed. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 7 illustrates an example computing device 700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device 700 are shown in electrical communication with each other using connection 705, such as a bus. The example computing device 700 includes a processing unit (CPU or processor) 710 and computing device connection 705 that couples various computing device components including computing device memory 715, such as read only memory (ROM) 720 and random access memory (RAM) 725, to processor 710.

Computing device 700 can include a cache of high-speed memory connected directly with, in close proximity to, or integrated as part of processor 710. Computing device 700 can copy data from memory 715 and/or the storage device 730 to cache 712 for quick access by processor 710. In this way, the cache can provide a performance boost that avoids processor 710 delays while waiting for data. These and other modules can control or be configured to control processor 710 to perform various actions. Other computing device memory 715 may be available for use as well. Memory 715 can include multiple different types of memory with different performance characteristics. Processor 710 can include any general purpose processor and a hardware or software service, such as service 1 732, service 2 734, and service 3 736 stored in storage device 730, configured to control processor 710 as well as a special-purpose processor where software instructions are incorporated into the processor design. Processor 710 may be a self-contained system, containing multiple cores or processors, a bus, memory controller, cache, etc. A multi-core processor may be symmetric or asymmetric.

To enable user interaction with the computing device 700, input device 745 can represent any number of input mechanisms, such as a microphone for speech, a touch-sensitive screen for gesture or graphical input, keyboard, mouse, motion input, speech and so forth. Output device 735 can also be one or more of a number of output mechanisms known to those of skill in the art, such as a display, projector, television, speaker device, etc. In some instances, multimodal computing devices can enable a user to provide multiple types of input to communicate with computing device 700. Communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. Storage device 730 can include services 732, 734, 736 for controlling processor 710. Other hardware or software modules are contemplated. Storage device 730 can be connected to the computing device connection 705. In one aspect, a hardware module that performs a particular function can include the software component stored in a computer-readable medium in connection with the necessary hardware components, such as processor 710, connection 705, output device 735, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus to process data, the apparatus comprising: one or more memories configured to store the data; and one or more processors coupled to the one or more memories and configured to: embed information generated from multivector inputs processed from input data associated with a three-dimensional space to a virtual node; process the multivector inputs using the virtual node to obtain a set of virtual tokens; and process, via a geometric algebra transformer, the set of virtual tokens to generate a set of output virtual tokens that are equivariant with respect to translations and rotations to the input data.
Aspect 2. The apparatus of Aspect 1, wherein the information generated comprise a center of mass and a set of eigenvectors.
Aspect 3. The apparatus of Aspect 2, wherein the center of mass and the set of eigenvectors are generated as a part of a principal component analysis (PCA).
Aspect 4. The apparatus of Aspect 3, wherein the one or more processors are configured to embed the information generated from multivector inputs based on all possible sign combinations of eigenvectors, from the set of eigenvectors, generated as a part of the PCA.
Aspect 5. The apparatus of Aspect 4, wherein the one or more processors are configured to: determine the eigenvectors with a positive determinant from the set of eigenvectors; and embed the information using the eigenvectors with positive determinants.
Aspect 6. The apparatus of any of Aspects 1-5, wherein the one or more processors are configured to decode the set of output virtual tokens to obtain a set of output tokens for output.
Aspect 7. The apparatus of Aspect 6, wherein the set of output virtual tokens are decoded using a cross-attention layer.
Aspect 8. The apparatus of any of Aspects 1-7, wherein the one or more processors are configured to embed the information generated from multivector inputs using portions of the geometric algebra transformer.
Aspect 9. The apparatus of Aspect 8, wherein the portions of the geometric algebra transformer comprise two bilinear layers and an equivariant layer.
Aspect 10. The apparatus of any of Aspects 1-9, wherein the geometric algebra transformer further comprises at least: an input equilinear layer; a geometric attention layer; and an output equilinear layer.
Aspect 11. A method to process data, the method comprising: embedding information generated from multivector inputs processed from input data associated with a three-dimensional space to a virtual node; processing the multivector inputs using the virtual node to obtain a set of virtual tokens; and processing, via a geometric algebra transformer, the set of virtual tokens to generate a set of output virtual tokens that are equivariant with respect to translations and rotations to the input data.
Aspect 12. The method of Aspect 11, wherein the information generated comprise a center of mass and a set of eigenvectors.
Aspect 13. The method of Aspect 12, wherein the center of mass and the set of eigenvectors are generated as a part of a principal component analysis (PCA).
Aspect 14. The method of Aspect 13, wherein embedding the information generated from multivector inputs is performed based on all possible sign combinations of eigenvectors, from the set of eigenvectors, generated as a part of the PCA.
Aspect 15. The method of Aspect 14, further comprising determining the eigenvectors with a positive determinant from the set of eigenvectors, wherein the embedding is performed using the eigenvectors with positive determinants.
Aspect 16. The method of any of Aspects 11-15, further comprising decoding the set of output virtual tokens to obtain a set of output tokens for output.
Aspect 17. The method of Aspect 16, wherein set of output virtual tokens are decoded using a cross-attention layer.
Aspect 18. The method of any of Aspects 11-17, wherein embedding the information generated from multivector inputs is performed using portions of the geometric algebra transformer.
Aspect 19. The method of Aspect 18, wherein the portions of the geometric algebra transformer comprise two bilinear layers and an equivariant layer.
Aspect 20. The method of any of Aspects 11-19, wherein the the geometric algebra transformer further comprises at least: an input equilinear layer; a geometric attention layer; and an output equilinear layer.
Aspect 21. A non-transitory computer-readable medium having stored thereon instructions that, when executed by at least one processor, cause the at least one processor to: embed information generated from multivector inputs processed from input data associated with a three-dimensional space to a virtual node; process the multivector inputs using the virtual node to obtain a set of virtual tokens; and process, via a geometric algebra transformer, the set of virtual tokens to generate a set of output virtual tokens that are equivariant with respect to translations and rotations to the input data.
Aspect 22. A non-transitory computer-readable medium having stored thereon instructions that, when executed by at least one processor, cause the at least one processor to perform operations according to any of one or more Aspects 11-20.
Aspect 23: An apparatus comprising one or more means for performing operations according to any one or more of Aspects 11-20.

What is claimed is:

1. An apparatus to process data, the apparatus comprising:
one or more memories configured to store the data; and
one or more processors coupled to the one or more memories and configured to:
embed information generated from multivector inputs processed from input data associated with a three-dimensional space to a virtual node;
process the multivector inputs using the virtual node to obtain a set of virtual tokens; and
process, via a geometric algebra transformer, the set of virtual tokens to generate a set of output virtual tokens that are equivariant with respect to translations and rotations to the input data.

2. The apparatus of claim 1, wherein the information generated comprise a center of mass and a set of eigenvectors.

3. The apparatus of claim 2, wherein the center of mass and the set of eigenvectors are generated as a part of a principal component analysis (PCA).

4. The apparatus of claim 3, wherein the one or more processors are configured to embed the information generated from multivector inputs based on all possible sign combinations of eigenvectors, from the set of eigenvectors, generated as a part of the PCA.

5. The apparatus of claim 4, wherein the one or more processors are configured to:
determine the eigenvectors with a positive determinant from the set of eigenvectors; and
embed the information using the eigenvectors with positive determinants.

6. The apparatus of claim 1, wherein the one or more processors are configured to decode the set of output virtual tokens to obtain a set of output tokens for output.

7. The apparatus of claim 6, wherein the set of output virtual tokens are decoded using a cross-attention layer.

8. The apparatus of claim 1, wherein the one or more processors are configured to embed the information generated from multivector inputs using portions of the geometric algebra transformer.

9. The apparatus of claim 8, wherein the portions of the geometric algebra transformer comprise two bilinear layers and an equivariant layer.

10. The apparatus of claim 1, wherein the geometric algebra transformer further comprises at least:
an input equilinear layer;
a geometric attention layer; and
an output equilinear layer.

11. A method to process data, the method comprising:
embedding information generated from multivector inputs processed from input data associated with a three-dimensional space to a virtual node;
processing the multivector inputs using the virtual node to obtain a set of virtual tokens; and
processing, via a geometric algebra transformer, the set of virtual tokens to generate a set of output virtual tokens that are equivariant with respect to translations and rotations to the input data.

12. The method of claim 11, wherein the information generated comprise a center of mass and a set of eigenvectors.

13. The method of claim 12, wherein the center of mass and the set of eigenvectors are generated as a part of a principal component analysis (PCA).

14. The method of claim 13, wherein embedding the information generated from multivector inputs is performed based on all possible sign combinations of eigenvectors, from the set of eigenvectors, generated as a part of the PCA.

15. The method of claim 14, further comprising determining the eigenvectors with a positive determinant from the set of eigenvectors, wherein the embedding is performed using the eigenvectors with positive determinants.

16. The method of claim 11, further comprising decoding the set of output virtual tokens to obtain a set of output tokens for output.

17. The method of claim 16, wherein the set of output virtual tokens are decoded using a cross-attention layer.

18. The method of claim 11, wherein embedding the information generated from multivector inputs is performed using portions of the geometric algebra transformer.

19. The method of claim 11, wherein the geometric algebra transformer further comprises at least:
an input equilinear layer;
a geometric attention layer; and
an output equilinear layer.

20. A non-transitory computer-readable medium having stored thereon instructions that, when executed by at least one processor, cause the at least one processor to:
embed information generated from multivector inputs processed from input data associated with a three-dimensional space to a virtual node;
process the multivector inputs using the virtual node to obtain a set of virtual tokens; and
process, via a geometric algebra transformer, the set of virtual tokens to generate a set of output virtual tokens that are equivariant with respect to translations and rotations to the input data.
